(19) United States
(12) Patent Application Publication
(10) Pub. No.: US 2025/0034801 A1
(43) Pub. Date: Jan. 30, 2025

(54) POLYPROPYLENE COMPOSITE MATERIAL FOR SAILCLOTH AND PROCESS FOR MANUFACTURING

(71) Applicant: ALUULA COMPOSITES INC., Victoria (CA)

(72) Inventors: Peter BERRANG, Victoria (CA); Richard MYERSCOUGH, Victoria (CA)

(73) Assignee: ALUULA COMPOSITES INC., Victoria, BC (CA)

(21) Appl. No.: 18/707,846

(22) PCT Filed: Nov. 16, 2022
(86) PCT No.: PCT/CA2022/051695

§ 371 Date: May 6, 2024

Related U.S. Application Data
(60) Provisional application No. 63/279,812, filed on Nov. 16, 2021.

(51) Int. Cl. D06N 3/00; D06N 3/04

(52) U.S. Cl. CPC D06N 3/0038; D06N 3/045; D06N 2201/0254; D06N 2209/103; D06N 2209/1628; D06N 2213/02

(57) ABSTRACT

A composite material, and a process for its manufacture is described. A film of polypropylene is layered over a textile core of isotactic polypropylene fibers and is fused to thereto by entangled polypropylene interposed between the textile core and the film so as to inhibit stretching of the textile core. The process includes positioning a film of polypropylene over a textile core of isotactic polypropylene fibers, and applying heat under pressure to the film so as to raise a film temperature above a melting point of the film while preventing melting of a crystalline component of the textile core to fuse the film to the textile core by causing entanglement of polypropylene of the textile core with polypropylene of the film so as to inhibit stretching of the textile core. The composite material is used for sailcloth.

### CROSS-REFERENCE TO RELATED APPLICATIONS

This application claims the benefit of, and priority to, U.S. Provisional Application No. 63/279,812 filed Nov. 16, 2021.

### TECHNICAL FIELD

The disclosure relates generally to sails, and more particularly to materials for sailcloth suitable for such sails as well for other applications.

### BACKGROUND

Sailing today is mostly considered a leisure activity, however throughout the ages it was the wind powered sailing vessels that found new worlds and provided the transportation of goods for global trading. Until the advent of plastics, sails were made of natural materials such as canvas using cotton as the primary ingredient. Susceptible to UV and moisture damage, canvas sails were also very heavy and cumbersome, requiring regular maintenance.

With the advent of plastics, new sail materials emerged, in particular tightly woven fabric made from polyethylene terephthalate (PET) fibers, also commonly referred to as Dacron™. More moisture resistant than canvas, with a much higher strength to weight ratio compared to canvas, Dacron™ has largely replaced canvas to become the industry standard in sailcloth. To further enhance Dacron's™ performance in sails, the fibers are often blended with other materials, such as elastane (spandex), nylon, or other fibers, and/or coated to reduce stretch or UV damage. However, materials such as Dacron™ have a problem with bias stretch, limiting their use in many practical applications. For Dacron™ sails, the woven material is controllably shrunk by careful heating to tighten and seal the weave openings, which adds processing cost but reduces the bias stretch.

Dacron™ sails have a density of about 1.38 g/cc and thus do not float in water. Dacron™ is damaged by UV over time, reducing its tensile and tear strength, requiring such a damaged sail to be replaced. When a Dacron™ sail is at the end of its usable life span it typically ends up in a landfill.

Some high performance sails are also made from high tenacity UHMWPE woven fabrics, which material is exceptionally strong for its weight, but relatively expensive. Efforts to reduce the bias stretch for such UHMWPE based fabrics is described in US Patent Application 2020/0139655 A1. There, a process is described that is directed to UHMWPE based fabrics that may have more than one melting point.

The most widely used commercially available isotactic polypropylene resin has only one melting point, generally considered to be about 165° C., depending on the purity of the base resin. Of note, pure isotactic polypropylene has a melting point of about 184° C., although this is not achieved in practice in a commercial/industrial setting. Accordingly, a melting point of 165° C. is generally considered accurate for isotactic polypropylene described herein. The chemical formula for polypropylene is as follows:

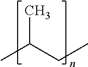

The tacticity of various polypropylenes may vary. Polypropylene may be modified chemically. For example, chlorination of the polypropylene may be possible.

The use of adhesives such as acrylics or epoxies for bonding a polymer film or films to resist bias stretching of fabrics such as polypropylene-based weaves is problematic, as such a bonding approach adds weight to the overall composite. Also, the low surface energy of polypropylene limits the selection, and strength, of adhesives that can be used. Additionally, adhesively bonded surfaces tend to delaminate over time when subjected to constant bond stress.

### SUMMARY

Sails are exposed to harsh conditions on a regular basis and therefore are prone to wear out. Replacement of sails can be expensive and entail considerable environmental cost, since new sails need to be manufactured and worn out sails disposed off. The sails are often disposed of in landfill as recycling can be difficult, not commercially viable, or even impossible in some cases. For example, due to the drawbacks of Dacron™ and other sailcloth materials used today, sailcloth is often made of fibers that are blended with other materials, such as elastane (spandex), nylon, or other fibers, and/or coated to reduce stretch or UV damage. Such blending can make recycling particularly challenging. There is a growing problem of polymer waste in landfills due to the accumulation of non-biodegradable sails. Improvement is desired. For example, it is desired to achieve a material of similar performance properties as Dacron™ while being easily recyclable at the end of its lifespan, i.e. a realistically recyclable sailcloth, and to achieve a process of manufacture that is also free of or provides a reduction in outgassing, liquid solvents, and other environmentally damaging steps during processing. For example, having a single polymer chemistry may be particularly suitable for recyclability.

As such a polypropylene-based construct was developed. To avoid the drawbacks of adhesives, heat fusing was attempted. However, a number of problems were experienced in attempting to heat fuse a bias stretch resisting fusion layer or a biaxially oriented bias stretch resisting fusion layer, to polypropylene fabric. The polypropylene fabric shrank, sometimes as much as 50%, when heat was applied during the fusing process. This shrinkage rendered the resulting composite polypropylene material unsuitable for use. This gave rise to the development of a method and process of manufacture of the composite polypropylene material.

In one aspect, there is described a composite material. The composite material comprises a textile core of isotactic polypropylene fibers. The composite material comprises a film of polypropylene layered over the textile core and fused to the textile core by entangled polypropylene interposed between the textile core and the film so as to inhibit stretching of the textile core.

In one aspect, there is described a process of manufacturing a composite material. The process comprises positioning a film of polypropylene over a textile core of isotactic polypropylene fibers. The process comprises applying heat under pressure to the film so as to raise a film temperature above a melting point of the film while preventing melting of a crystalline component of the textile core to fuse the film to the textile core by causing entanglement of polypropylene of the textile core with polypropylene of the film so as to inhibit stretching of the textile core.

In one aspect, there is described a sailcloth. The sailcloth comprises a textile core of isotactic polypropylene fibers. The sailcloth comprises a first film of polypropylene layered over the textile core and fused to the textile core by entangled polypropylene interposed between the textile core and the first film. The sailcloth comprises a second film of polypropylene layered over the textile core opposite to the first film to sandwich the textile core between the first and second films, the second film being fused to the textile core by entangled polypropylene interposed between the textile core and the second film so as to further inhibit bias stretching of the textile core.

In one aspect, the disclosure describes an isotactic-based polypropylene fiber woven, knit or non-woven construct for use as sailcloth is disclosed. This construct is comprised of a core woven, knit, or non-woven layer of isotactic polypropylene fibers, which fibers have a plain weave, twill weave, satin weave, leno weave, knit configuration, or even spunbond, which woven or non-woven layer is bonded on at least one side, or both sides, with a layer of syndiotactic polypropylene film. By heating such layers, with light or modest compression at a temperature range of about 130-160° C., for a dwell time of at least 1 minute, preferably 10 minutes, but not limited in duration, such layers fuse, to form a “fusion” layer containing a polymer chain entanglement from polymers of each of the core layer and fusion layers, and where such entanglement may be aided by van der Waals forces of the entangled polymer chains. The composition of the entanglement layer is comprised of not only isotactic configured polypropylene monomer units, but also syndiotactic polypropylene monomer units.

In some embodiments, the core woven, knit or non-woven layer of isotactic polypropylene fibers, which fibers have a plain weave, twill weave, satin weave, leno weave, knit configuration, or even spunbond, which woven or non-woven layer is bonded on at least one side, or both sides, with a layer of chemically modified polypropylene film, where such film includes, for example, ethylene and butene based random copolymers as additives in the polypropylene polymer backbone. Copolymer doping can alter the physical parameters of the pure polypropylene resin, and be adapted to reduce the melt point, from, for example, 165° C. to about 130° C. By heating such layers, with light or modest compression at a temperature range of about 130-160° C., for a dwell time of at least 1 minute, preferably, 10 minutes, or about 1 hour, such layers fuse to form a “fusion” layer containing a polymer chain entanglement from polymers of each of the core layer and fusion layer.

In some embodiments, the core woven, knit, or non-woven layer of isotactic polypropylene fibers, which fibers have a plain weave, twill weave, satin weave, leno weave, knit configuration, or even spunbond, which woven or non-woven layer is bonded on at least one side, or both sides, with a layer of chlorinated polypropylene film, which film can be made with a melting temperature of 100-120° C. However, such film may be difficult recyclable, and can emit corrosive hydrochloric acid fumes as determined during experimentation of this material. However, such chlorinated polypropylene film does heat bond to isotactic polypropylene. By heating such layers, with light or modest compression at a temperature range of about 100-140° C., for a dwell time of at least 1 minute, preferably 10 minutes, but not limited in duration, such layers fuse, to form a “fusion” layer containing a polymer chain entanglement from polymers of each of the core layer and fusion layers, and where such entanglement may be aided by van der Waals forces of the entangled polymer chains.

In some embodiments, the core woven layer of isotactic polypropylene fibers, which fibers have a plain weave, twill weave, satin weave, leno weave, knit configuration, or even spunbond, which woven, knit or non-woven layer is bonded on at least one side, or both sides, with an isotactic polypropylene film, where such film has the same melt temperature as the core woven layer. For this embodiment, it is important to tightly clamp the core woven, knit, or non-woven layer to prevent it from shrinking during heating, where such shrinkage of the woven, knit or non-woven fibers starts about 140° C., up to about 170° C. where the shrinkage is over 50%. Accordingly, this construct can be fused together at a temperature range from about 160° C. up to about 170° C., as the now-constrained crystalline fibers in the weave, knit, or non-woven layer are prevented from shrinking, with the amorphous components from the fusion film and the weave entangling to form a strong fusion bond.

Further details of these and other aspects of the subject matter of this application will be apparent from the detailed description included below and the drawings.

Embodiments can include combinations of the above features.

### DESCRIPTION OF THE DRAWINGS

Reference is now made to the accompanying drawings, in which:

FIG. 1 illustrates sails 10 engaged on a sailboat 12;

FIG. 2 is a schematic exploded view of a two-layer composite material 20, in accordance with an embodiment:

FIG. 3 is a schematic cross-sectional view of the sail 10, in accordance with an embodiment; and

FIG. 4 is a schematic flow chart of a process of manufacturing a composite material, in accordance with an embodiment.

### DETAILED DESCRIPTION

There is described a polypropylene-based fabric construct. This fabric construct was developed for use in making low cost sails that can be recycled after their useful lifespan.

A polypropylene-based construct is described. The construct has a woven, knit. or non-woven isotactic polypropylene fiber core, with a melting point of about 165° C., heat fused on at least one side to a polypropylene film, at a temperature range of 130-160° C., and where said film has been chemically modified to melt at a temperature lower than the melting temperature of the crystalline component of said woven core. The fusion interface between the woven core and fused film contains an entanglement layer of different polymer domains from both the fiber core and the fused film. The construct may be used as sailcloth or in other articles of manufacture. Said construct may be recyclable, low cost, UV resistant and may be a density of less than 1 g/cc. The composite material may comprise a core layer of plain woven, knit or non-woven isotactic polypropylene fibers, with both sides of said fabric fused to a lower melting point polypropylene film, such film having a syndiotactic configuration or a configuration having doped ethylene and butene based random copolymers. The fused films may serve to decrease the bias stretch of the woven, knit, or non-woven fabric construct, and seal the porous openings in the woven, knit and non-woven fabric.

A composite polypropylene material and a method of manufacturing the same will now be described with reference to the drawings.

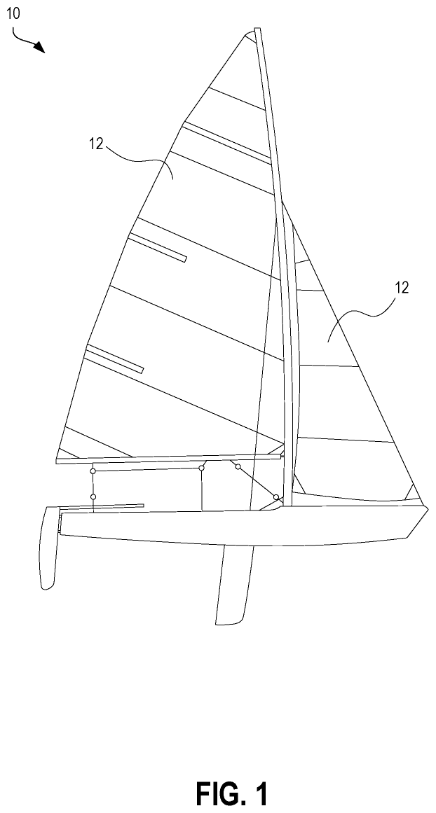

FIG. 1 illustrates sails 10 engaged on a sailboat 12. Such sails 10 may be made of sailcloth.

The sails 10 are used in harsh environments and are susceptible to failure. This is one application for which the composite polypropylene material was developed. However, it is understood that the composite material is suitable for use in other applications, such as tents, tarps and carry-bags.

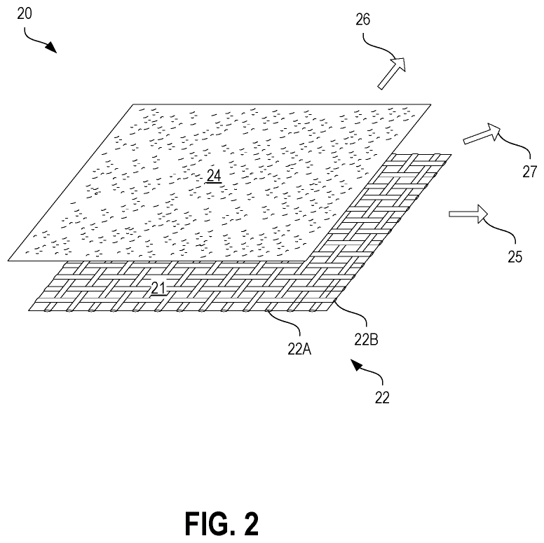

FIG. 2 is a schematic exploded view of a two-layer composite material 20, in accordance with an embodiment.

The composite material 20 includes a textile core 21 and a film 24. The textile core 21 may be a woven, knit or non-woven layer. The film 24 may define a stretch resisting fusion layer. The textile core 21 is made of isotactic polypropylene fibers 22.

In various embodiments, the textile core 21 may be woven or non-woven polypropylene fabric and may be made using one or more weave patterns, such as plain, twill, satin, leno, knitted, knit configuration, or even or non-woven spunbond. Such textile core 21 may have an aerial weight of 20-200 gsm (grams per square meter) or, in some embodiments, 50-250 gsm, with a fiber denier of 50-500. It is found that an aerial weight of 100-120 gsm is particularly advantageous. For example, in some embodiments, the textile core 21 is a single ply of woven isotactic polypropylene fabric. In some cases, the textile core may be a non-woven polypropylene fabric.

In some embodiments, woven textile core is found to be particularly advantageous.

Warp fibers 22B are oriented in a first direction 25 and weft fibers 22A are oriented in a second direction 26 and orthogonal to the first direction 25. A bias direction 27 is also indicated.

The textile core 21 has a first face and a second face opposite to the first face. The film 24 is fused to at least one of first face or second face. In various embodiments, the tensile strength of the warp fibers 22B and weft fibers 22A are within 50%, preferably 25%, preferably the same. Other types of fabric weave patterns, for example, twill weave, can also be used.

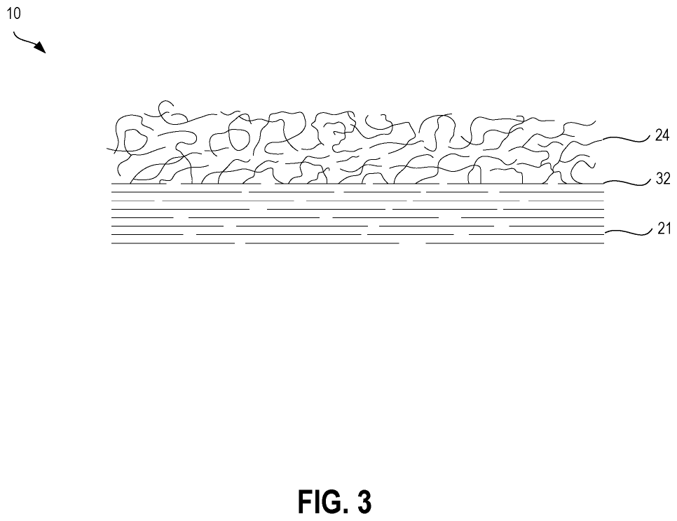

FIG. 3 is a schematic cross-sectional view of the sail 10, in accordance with an embodiment. FIG. 3 is a sketch showing a cross-section of the entangled polymer chains from the isotactic polypropylene weave, knit or non-woven layer and the fused polypropylene film. It is understood that in other embodiments, such a composite material may be used in other applications, such as for bags, tents, and tarps.

In some embodiments, the textile core 21 is unconstrained, and is comprised of polypropylene fibers that have an isotactic molecular structure. Such fibers' polymer structure may be highly linearly aligned with high crystalline content.

The fusing of the film 24 and the textile core 21 is described further below with respect to specific embodiments. In general, the film 24 is layered over the textile core 21 and fused to the textile core 21 by entangled polypropylene interposed between the textile core 21 and the film 24 so as to inhibit stretching of the textile core 21. In other words, after fusing film 24 and textile core 21 (e.g. a fabric), a bonding interface 32 may be formed between film 24 and textile core 21. This interface 32 may comprise entangled polymer chains, thereby providing a strong adhesive force between film 24 and textile core 21. Interestingly, such fusion bonding may occur without actually melting the crystalline component of textile core 21. In some embodiments, the film 24 is a first film, and a second film of polypropylene is layered over the textile core 21 to sandwich the textile core 21 between the first and second films. Such a second film may be bonded to the textile core 21 in a manner similar to the first film.

In general, the entangled polypropylene includes an amorphous component of the textile core 21 and an amorphous component of the film 24. Entangled polymers may refer to the amorphous arrangement of the polymer chains, which, when at least one side of two isotactic polypropylene surfaces melt, the amorphous structure of the film (or weave) “melt at their surfaces”, and thereby entangle, to cause fusing. The fusion layer is comprised of a mix of amorphous polypropylene chains.

In various embodiments, the entangled polypropylene interposed between the textile core 21 and the film 24 is adhesive-free since no adhesive is used for bonding and fusion. This may be particularly advantageous due to the draw backs of using adhesives.

The film 24 may have a lower melting point than the textile core 21, which may aid in the fusion of the film 24 to the textile core 21. In various embodiments, a melting point of the film 24 is below: 160° C. and a melting point of a crystalline component of the textile core 21 is above 165° C.

In various embodiments, the polypropylene in the film 24 is chemically modified to lower its melting point. Various examples of such chemically modified polypropylene are described now. In some embodiments, film 24 may comprise polypropylene doped with one or more dopants to reduce its melting point (the chemically modified polypropylene). Dopants such as ethylene and butene (together) may be added to reduce the film melting point to about 130° C. As a result, the polypropylene may have a backbone with both ethylene and butene domains. Such lowering of the melt temperature of the film may allow fusing film 24 to textile core 21 at a temperature range of 130-160° C., which range does not melt the crystalline component of the textile core 21. For example, in some embodiments, only light pressure may be necessary for fusing over a dwell time of at least 1 minute or more. In some embodiments, the dwell time may be at least 10 minutes. In some embodiments, the dwell time may be about 1 hour. In some embodiments, pressure of at least 5 psi may be applied. In some embodiments, pressure of at least 15 psi may be applied. In various embodiments, the interface 32 then forms a strong contiguous bond between film 24 and textile core 21. Such an interface may contain entanglement of isotactic polypropylene, and polypropylene backbone having ethylene and butene domains.

In some embodiments, a fabric layer of isotactic polypropylene fibers (a second set of isotactic polypropylene fibers), which have fibers oriented at 45 degrees to the warp fibers 22B, may be bonded (sandwiched) between film 24 and textile core 21.

In some embodiments, the textile core 21 is unconstrained, and is comprised of polypropylene fibers that have an isotactic molecular structure. Such fibers polymer structure may be highly linearly aligned with high crystalline content. For this alternate embodiment, film 24 may comprise polypropylene film with an syndiotactic molecular structure, which structure reduces its melting point from about 165° C. to 130° C. Such lowering of the melt temperature of the film may allow fusing film 24 to textile core 21 at a temperature range of 130-160° C., which range does not melt the crystalline component of textile core 21. For example, in some embodiments, only light pressure may be necessary for fusing over a dwell time of at least 1 minute or more. In some embodiments, the dwell time may be at least 10 minutes. In some embodiments, pressure of at least 5 psi may be applied. In some embodiments, pressure of at least 15 psi may be applied. After fusing film 24 and textile core 21, a bonding interface 32 is formed between film 24 and textile core 21. This interface 32 is comprised of entangled polymer chains, including isotactic polypropylene and syndiotactic polypropylene, thereby providing a strong adhesive force between film 24 and textile core 21. Interestingly, such fusion bonding can occur without actually melting the crystalline component of textile core 21. The interface 32 may form a strong contiguous bond between film 24 and textile core 21, which interface contains entanglement of isotactic and syndiotactic polypropylene.

In some embodiments, a fabric layer of isotactic polypropylene fibers, which have fibers oriented at 45 degrees to the warp direction fibers, may be bonded between film 24 and textile core 21.

In some embodiments, textile core 21 may be constrained (e.g. by clamping) to prevent it from shrinking during heating, and is comprised of polypropylene fibers that have an isotactic molecular structure. Such fibers' polymer structure is highly linearly aligned with high crystalline content. For this embodiment, film 24 is comprised of isotactic polypropylene film having substantially the same melt temperature as textile core 21. Fusing film 24 to textile core 21 may be done at a temperature range of 160-170° C., which range does not melt the crystalline component of textile core 21, if textile core 21 is tightly constrained from shrinking. A dwell time of at least 1 minute or more may be used. In some embodiments, the dwell time may be at least 10 minutes. After fusing film 24 and textile core 21, a bonding interface 32 is formed between film 24 and textile core 21. This interface 32 is comprised of entangled polymer chains, thereby providing a strong adhesive force between film 24 and textile core 21. Interestingly, such fusion bonding can occur without actually melting the crystalline component of textile core 21. The interface 32 may form a strong contiguous bond between film 24 and textile core 21, which interface contains entanglement of only isotactic polypropylene domains.

In some embodiments, a fabric or non-woven layer of isotactic polypropylene fibers, which have fibers oriented at 45 degrees to the warp direction fibers, may be bonded between film 24 and textile core 21.

In some embodiments, the core woven or non-woven layer of isotactic polypropylene fibers, textile core 21, which fibers have a plain weave, twill weave, satin weave, leno weave, knit or spunbonded configuration, which the woven or non-woven layer is bonded on at least one side, preferably both sides, with a layer of chlorinated polypropylene film 24 (the chemically modified polypropylene), which film 24 can be made with a melting temperature of 100-120° C. However, such film may be hard to recycle and may emit corrosive hydrochloric acid fumes as determined during experimentation of this material. However, such chlorinated polypropylene film does heat bond to isotactic polypropylene. For example, in some embodiments, only light pressure may be sufficient for fusing over a dwell time of at least 1 minute or more. In some embodiments, the dwell time may be at least 10 minutes. In some embodiments, pressure of at least 5 psi may be applied. In some embodiments, pressure of at least 15 psi may be applied.

In some embodiments, the film 24 is applied to a first face of the textile core 21 and a second film is applied to a second face of the textile core 21 that is opposite the first face so as to sandwich the textile core 21 in-between films. The two fusion layers may both be adhesive free.

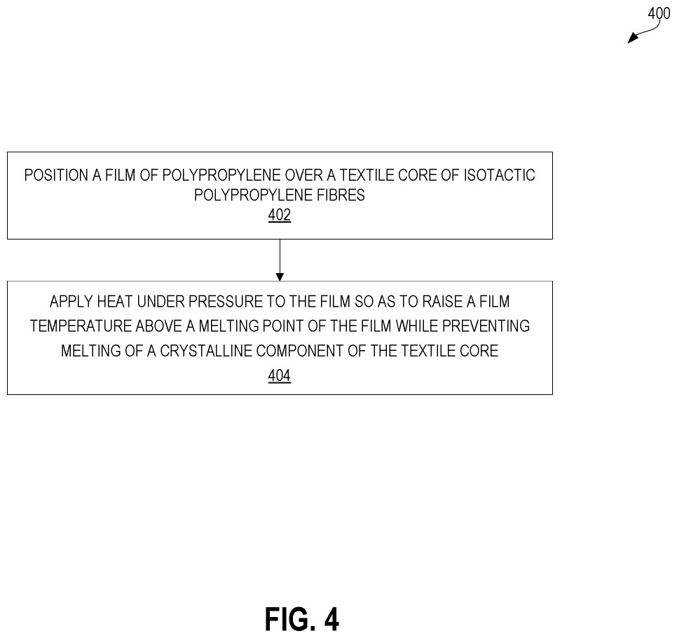

FIG. 4 is a schematic flow chart of a process 400 of manufacturing a composite material, in accordance with an embodiment.

Step 402 of the process includes positioning a film of polypropylene over a textile core of isotactic polypropylene fibers.

Step 404 of the process includes applying heat under pressure to the film so as to raise a film temperature above a melting point of the film while preventing melting of a crystalline component of the textile core to fuse the film to the textile core by causing entanglement of polypropylene of the textile core with polypropylene of the film so as to inhibit stretching of the textile core. In some embodiments of the process 400, the melting point of the film is below 160° C.

In some embodiments of the process 400, the film includes chlorinated polypropylene, and step 404 includes raising the film temperature to above 100° C. while preventing the film temperature to rise above 140° C. for a dwell time of at least 1 minute.

In some embodiments of the process 400, the dwell time is at least 10 minutes.

In some embodiments of the process 400, step 404 includes applying a pressure of at least 5 psi.

In some embodiments of the process 400, step 404 includes applying a pressure of at least 15 psi.

In some embodiments of the process 400, the film includes syndiotactic polypropylene, and step 404 includes raising the film temperature to above 130° C. while preventing the film temperature to rise above 160° C. for a dwell time of at least 1 minute.

In some embodiments of the process 400, the dwell time is at least 10 minutes.

In some embodiments of the process 400, step 404 includes applying a pressure of at least 5 psi.

In some embodiments of the process 400, step 404 includes applying a pressure of at least 15 psi.

In some embodiments of the process 400, the film includes isotactic polypropylene, and step 404 includes raising the film temperature to above 160° C. while preventing the film temperature to rise above 170° C. for a dwell time of at least 1 minute

Some embodiments of the process 400 further comprise constraining the textile core while a textile core temperature is above 140° C. to prevent shrinkage and to constrain the crystalline component.

In some embodiments of the process 400, the dwell time is at least 10 minutes.

In some embodiments of the process 400, step 404 includes applying a pressure of at least 5 psi.

In some embodiments of the process 400, step 404 includes applying a pressure of at least 15 psi.

In some embodiments of the process 400, the film includes polypropylene with a backbone having ethylene and butene domains and step 404 includes raising the film temperature to above 130° C. while preventing the film temperature to rise above 160° C. for a dwell time of at least 1 minute.

In some embodiments of the process 400, the dwell time is at least 10 minutes.

It is understood that reference to “film” in a (finished) composite material here refers to the material that forms upon applying a film to a textile core. For example, a film in a composite material may be deformed and melt into openings of a weave of the textile core.

As can be understood, the examples described above and illustrated are intended to be exemplary only.

The embodiments described in this document provide non-limiting examples of possible implementations of the present technology. Upon review of the present disclosure, a person of ordinary skill in the art will recognize that changes may be made to the embodiments described herein without departing from the scope of the present technology. For example, composites materials may include those with three, four, or more layers, and may be cut and prepared for application in uses such as for tents, bags, tarps, and garments. Yet further modifications could be implemented by a person of ordinary skill in the art in view of the present disclosure, which modifications would be within the scope of the present technology.

What is claimed is:

1. A composite material, comprising:
a textile core of isotactic polypropylene fibers; and
a film of polypropylene layered over the textile core and fused to the textile core by entangled polypropylene interposed between the textile core and the film so as to inhibit stretching of the textile core.

2. The composite material of claim 1, wherein the entangled polypropylene interposed between the textile core and the film is adhesive-free.

3. The composite material of claim 1, wherein the film is a first film, the composite material further comprising:
a second film of polypropylene layered over the textile core to sandwich the textile core between the first and second films, the second film being fused to the textile core by entangled polypropylene interposed between the textile core and the second film so as to further inhibit bias stretching of the textile core.

4. The composite material of claim 1, wherein the film has a lower melting point than the textile core.

5. The composite material of claim 4, wherein the polypropylene in the film is chemically modified polypropylene, and the lower melting point is associated with the chemically modified polypropylene.

6. The composite material of claim 5, wherein the chemically modified polypropylene includes polypropylene with a backbone having ethylene and butene domains.

7. The composite material of claim 5, wherein the chemically modified polypropylene includes chlorinated polypropylene.

8. The composite material of claim 4, wherein the film includes syndiotactic polypropylene and the entangled polypropylene includes isotactic polypropylene and syndiotactic polypropylene.

9. The composite material of claim 1, wherein the polypropylene in the film is isotactic polypropylene.

10. The composite material of claim 1, wherein the entangled polypropylene includes an amorphous component of the textile core and an amorphous component of the film.

11. The composite material of claim 1, wherein a melting point of the film is below 160° C. and a melting point of a crystalline component of the textile core is above 165° C.

12. The composite material of claim 1, wherein the isotactic polypropylene fibers in the textile core are woven.

13. The composite material of claim 1, wherein the textile core comprises a second set of isotactic polypropylene fibers oriented at 45 degrees relative to a warp direction of the isotactic polypropylene fibers.

14. A sailcloth composed of a composite material of any one of claims 1 to 13.

15. A process of manufacturing a composite material, comprising:
(a) positioning a film of polypropylene over a textile core of isotactic polypropylene fibers; and
(b) applying heat under pressure to the film so as to raise a film temperature above a melting point of the film while preventing melting of a crystalline component of the textile core to fuse the film to the textile core by causing entanglement of polypropylene of the textile core with polypropylene of the film so as to inhibit stretching of the textile core.

16. The process of claim 15, wherein the melting point of the film is below 160° C.

17. The process of claim 15, wherein the film includes chlorinated polypropylene, and step (b) includes raising the film temperature to above 100° C. while preventing the film temperature to rise above 140° C. for a dwell time of at least 1 minute.

18. The process of claim 17, wherein the dwell time is at least 10 minutes.

19. The process of claim 17, wherein step (b) includes applying a pressure of at least 5 psi.

20. The process of claim 17, wherein step (b) includes applying a pressure of at least 15 psi.

21. The process of claim 15, wherein the film includes syndiotactic polypropylene, and step (b) includes raising the film temperature to above 130° C. while preventing the film temperature to rise above 160° C. for a dwell time of at least 1 minute.

22. The process of claim 21, wherein the dwell time is at least 10 minutes.

23. The process of claim 21, wherein step (b) includes applying a pressure of at least 5 psi.

24. The process of claim 21, wherein step (b) includes applying a pressure of at least 15 psi.

25. The process of claim 15, wherein the film includes isotactic polypropylene, and step (b) includes raising the film temperature to above 160° C. while preventing the film temperature to rise above 170° C. for a dwell time of at least 1 minute, the process further comprising:
constraining the textile core while a textile core temperature is above 140° C. to prevent shrinkage and to constrain the crystalline component.

26. The process of claim 25, wherein the dwell time is at least 10 minutes.

27. The process of claim 25, wherein step (b) includes applying a pressure of at least 5 psi.

28. The process of claim 25, wherein step (b) includes applying a pressure of at least 15 psi.

29. The process of claim 15, wherein the film includes polypropylene with a backbone having ethylene and butene domains and step (b) includes raising the film temperature to above 130° C. while preventing the film temperature to rise above 160° C. for a dwell time of at least 1 minute.

30. The process of claim 29, wherein the dwell time is at least 10 minutes.

31. A composite material manufactured by the process of any one of claims 15 to 30.

32. A sailcloth, comprising:
a textile core of isotactic polypropylene fibers:
a first film of polypropylene layered over the textile core and fused to the textile core by entangled polypropylene interposed between the textile core and the first film; and
a second film of polypropylene layered over the textile core opposite to the first film to sandwich the textile core between the first and second films, the second film being fused to the textile core by entangled polypropylene interposed between the textile core and the second film so as to further inhibit bias stretching of the textile core.

33. The sailcloth of claim 32, wherein the entangled polypropylene interposed between the textile core and the first film is adhesive-free, and the entangled polypropylene interposed between the textile core and the second film is adhesive-free.
